(19) United States
(12) Patent Application Publication
(10) Pub. No.: US 2008/0089075 A1
(43) Pub. Date: Apr. 17, 2008

(54) Illuminating ornament with multiple power supply mode switch

(76) Inventor: Fu-Hsien Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/580,986

(22) Filed: Oct. 16, 2006

(51) Int. Cl. F21L 19/00; F21V 15/00; F21V 3/00

(52) U.S. Cl. 362/363; 362/173; 362/800; 362/806; 362/809

(57) ABSTRACT

Disclosed is an illuminating ornament including a cover, a circuit board provided inside the cover, at least one illuminating element, a switch provided with a DC power supply input and an AC-to-DC power supply input and is electrically connected to the circuit board, a DC power supply circuit electrically connected to the circuit board through the DC power supply input, an AC-to-DC supplying circuit electrically connected to the circuit board through the AC-to-DC power supply input of the switch and is provided with an AC-to-DC converting circuit, an AC power input and an AC power output. AC power is converted to DC power by the AC-to-DC converting circuit and provided to the illuminating element through the AC power output.

### FIELD OF THE INVENTION

The present invention relates to an illuminating ornament, and in particular to an illuminating ornament with a multiple power supply mode switch.

### BACKGROUND OF THE INVENTION

Since it is well accepted that it would be somehow difficult for an ordinary, simple illuminating device without ornaments or decorations to attract consumers' attention nowadays, well designed, decorated Christmas lights and lampshades are what attract people's notice. By way of example, disclosed in R.O.C. Patent No. 00346172 is a multifunctional flashlight with a decorative lid.

Although conventional illuminating devices as discussed above are provided with decorated lampshades, lids and/or covers, they are powered by the batteries of the flashlight; many inconveniences to the users and consumers have arise due to the necessity of the replacing of the dead batteries.

### SUMMARY OF THE INVENTION

A primary object of the present invention, therefore, is to provide an illuminating ornament with a multiple power supply mode switch to utilize both direct current and alternating current as power supply.

Another object of the present invention is to provide a transparent ornament provided proximity to the illuminating element of the device in order to manipulate the light generated by the illuminating element.

In order to realize the above objects, the present invention installs an illuminating ornament including a cover, a circuit board provided inside the cover, at least one illuminating element, a switch provided with a DC power supply input and an AC-to-DC power supply input and is electrically connected to the circuit board, a DC power supply circuit electrically connected to the circuit board through the DC power supply input, an AC-to-DC supplying circuit electrically connected to the circuit board through the AC-to-DC power supply input of the switch and is provided with an AC-to-DC converting circuit, an AC power input and an AC power output. AC power is converted to DC power by the AC-to-DC converting circuit and provided to the illuminating element through the AC power output.

In preferred embodiment of the present invention, the illuminating ornament further includes a detecting circuit provided with a detecting switch at a first end and a detecting connector at a second end, and the AC power input is further provided with a conducting wire. In addition, the cover is provided on the top surface of a transparent body, and the transparent body further includes a containing space and a transparent ornament located at a predetermined position inside the containing space. The illuminating element illuminates and the illuminated transparent ornament of the transparent body displays different streams of light.

In comparison with the conventional technologies, the illuminating ornament of the present invention benefits users and consumers by utilizing both direct current and alternating current as power supply to overcome the drawback of solely relying on batteries. Moreover, the present invention draws more notices and attention by eye-dazzling visual effects; hence makes it much easier to market and sell.

These and other objects, features and advantages of the invention will be apparent to those skilled in the art, from a reading of the following brief description of the drawings, the detailed description of the preferred embodiment, and the appended claims.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an illuminating ornament in accordance with the present invention;

FIG. 2 is an assembled perspective view of the illuminating ornament in accordance with the present invention;

FIG. 3 is a vertical view of the illuminating ornament in accordance with the present invention;

FIG. 4 shows a conducting plug of the illuminating ornament connected to a detecting circuit; and

FIG. 5 shows the conducing plug of the illuminating ornament connected to an AC-to-DC supplying circuit.

### DETAILED DESCRIPTION OF THE PREFERRED EMBODIMENTS

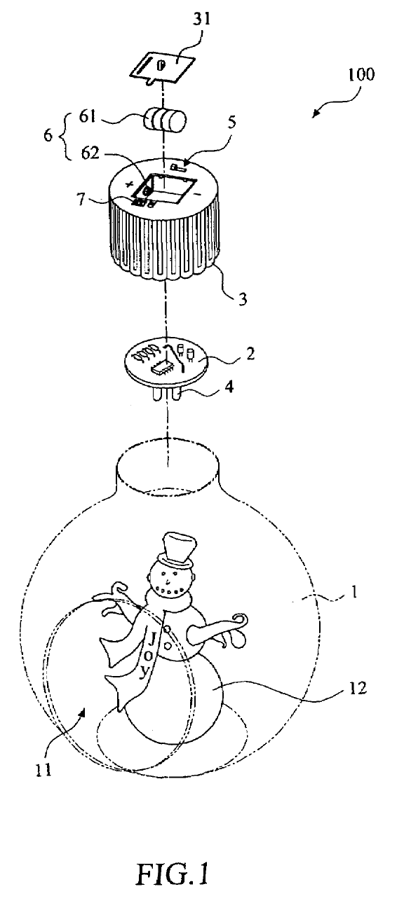

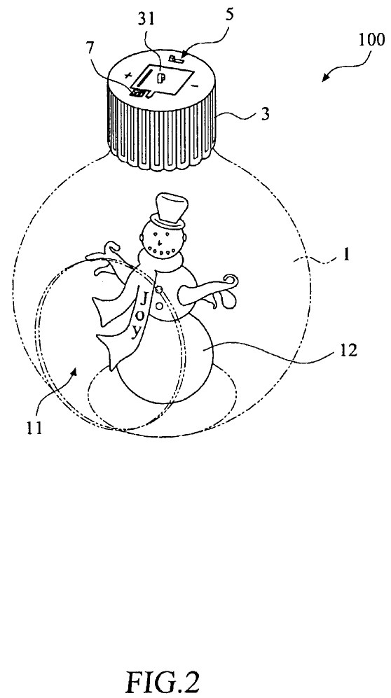

With reference to the drawings and in particular to FIG. 1 and FIG. 2 that are exploded perspective view of an illuminating ornament and assembled perspective view of the illuminating ornament in accordance with the present invention, respectively. As shown in the figures, the illuminating ornament 100 includes a transparent body 1, a circuit board 2 and a cover 3, wherein the transparent body 1 further includes a containing space 11 and a transparent ornament 12 located at a predetermined position inside the containing space 11. The circuit board 2, provided inside the cover 3, is provided with a plurality of electronic elements on its topside and two illuminating elements 4 on the bottom side.

The cover is provided on the topside of the transparent body 1 and is provided with a switch 5, a DC power supply circuit 6 and a conductive plug 7 at a predetermined position. The position where the DC power supply circuit 6 is located is covered by a lid 31 to ensure the smooth of the surface of the cover 3.

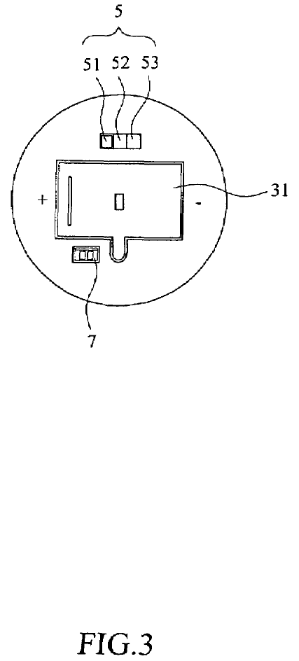

Please refer to FIG. 3, which is a vertical view of the illuminating ornament, the switch 5 is electrically connected to the circuit board 2 with a DC power supply input 51, a DC power detecting input 52 and an AC-to-DC power supply input 53. The DC power supply circuit 6 is electrically connected to the circuit board 2 through the DC power supply input 51 of the switch 5, and is provided with a plurality of batteries 61 and a conductive spring 62 that are electrically connected to the illuminating element 4 through the DC power supply circuit 6 to provide power to the illuminating element 4. The conductive plug 7 is electrically connected to the circuit board 2 through the DC power detecting input 52 and the AC-to-DC power supply input 53 of the switch 5.

When making use of the illuminating ornament 100, first switch the switch 5 to the DC power supply input 51 to provide the illuminating element 4 direct current power through the DC power supply circuit 6. As a consequence, the illuminating element 4 illuminates and the illuminated transparent ornament 12 of the transparent body displays different streams of light.

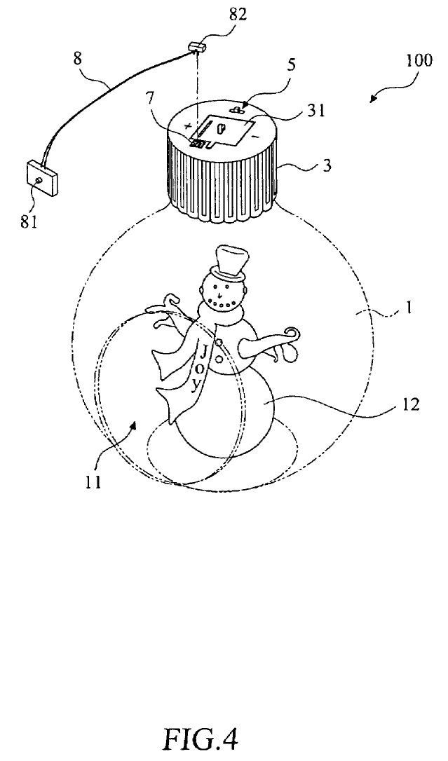

Please refer to FIG. 4 that shows a conducting plug of the illuminating ornament connected to a detecting circuit, the illuminating ornament 100 is further provided with a detecting circuit 8 to detect the status of the illuminating element 4. The detecting circuit 8 is provided with a detecting switch 81 at a first end and a detecting connector 82 at a second end. When the detecting connector 82 of the detecting circuit 8 is plugged into the conductive plug 7 of the illuminating ornament 100, and the switch 5 is switched to the DC power detecting input 52, the pressing of the detecting switch 81 makes the illuminating element 4 illuminate and the releasing of the switch 81 stops the illuminating of the element 4.

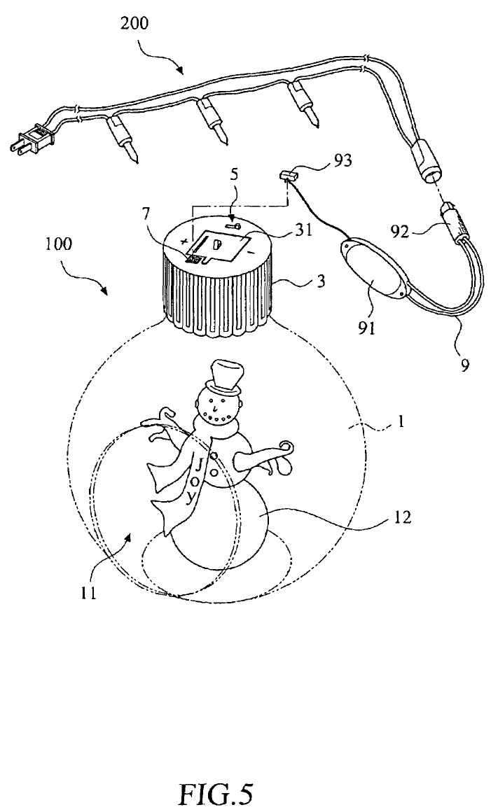

As shown in FIG. 5, which shows the conducing plug of the illuminating ornament connected to an AC-to-DC supplying circuit, the illuminating ornament 100 is further provided with an AC-to-DC supplying circuit 9 to illuminate the illuminating element 4. The AC-to-DC supplying circuit 9 includes an AC-to-DC converting circuit 91, an AC power input 92 and an AC power output 93, wherein the converting circuit 91 is connected to the AC power input 92 and the AC power output 93. In addition, the AC power input 92 is further provided with a conducting wire 200 to conduct AC power to the AC-to-DC supplying circuit 9. When the AC power output 93 of the AC-to-DC supplying circuit 9 is plugged to the conductive plug 7 of the illuminating ornament 100, and the switch 5 is switched to the AC-to-DC power supply input 53, AC power conducted by the conducting wire 200 is conducted to the AC power input 92 of the AC-to-DC power supplying circuit 9, converted to DC power by the AC-to-DC converting circuit 91, and provided to the illuminating element 4 through the AC power output 93.

It is obvious to those skilled in the art that the illuminating element may be light bulbs, light emitting diodes (LED) or any other conventional light-emitting element. Additionally, it is also obvious that the AC-to-DC supplying circuit may be a rectifier and/or a commutator.

While the invention has been described in connection with what is presently considered to the most practical and preferred embodiments, it is to be understood that the invention is not to be limited to the disclosed embodiments, but on the contrary, is intended to cover various modifications and equivalent arrangement included within the spirit and scope of the appended claims.

What is claimed is:

1. An illuminating ornament, comprising:
a cover;
a circuit board provided inside the cover;
at least one illuminating element provided on the bottom side of the circuit board;
a switch provided with a DC power supply input and an AC-to-DC power supply input, and is provided at a predetermined position of the cover and electrically connected to the circuit board;
a DC power supply circuit electrically connected to the circuit board through the DC power supply input and is provided with at least one battery connected to the illuminating element; and
an AC-to-DC supplying circuit electrically connected to the circuit board through the AC-to-DC power supply input of the switch, and is provided with an AC-to-DC converting circuit, an AC power input and an AC power output;
wherein AC power is converted to DC power by the AC-to-DC converting circuit and provided to the illuminating element through the AC power output.

2. The illuminating ornament as claimed in claim 1, further comprising a detecting circuit provided with a detecting switch at a first end and a detecting connector at a second end.

3. The illuminating ornament as claimed in claim 1, wherein the AC power input is further provided with a conducting wire.

4. The illuminating ornament as claimed in claim 1, wherein the cover further comprising a conductive plug electrically connected to the circuit board through the DC power detecting input and the AC-to-DC power supply input of the switch.

5. The illuminating ornament as claimed in claim 1, wherein the cover is provided on the top surface of a transparent body.

6. The illuminating ornament as claimed in claim 5, wherein the transparent body further comprising a containing space and a transparent ornament located at a predetermined position inside the containing space.
